(19) United States
(12) Patent Application Publication
(10) Pub. No.: US 2026/0257852 A1
(43) Pub. Date: Sep. 3, 2026

(54) Portable Thermal Insulated Apparatus

(71) Applicant: Blue Dot Rising, Inc., Long Beach, CA (US)

(72) Inventor: Lara Vu, Long Beach, CA (US)

(73) Assignee: Blue Dot Rising, Inc., Long Beach, CA (US)

(21) Appl. No.: 19/651,826

(22) Filed: Apr. 20, 2026

Related U.S. Application Data
(63) Continuation of application No. 18/203,790, filed on May 31, 2023.
Application No. 18/203,790 is a continuation of application No. 17/583,406, filed on Jan. 25, 2022, now Pat. No. 11,702,272.
Application No. 17/583,406 is a continuation of application No. 16/802,648, filed on Feb. 27, 2020, now Pat. No. 11,267,642.
Application No. 16/802,648 is a continuation of application No. 29/692,216, filed on May 23, 2019, now Pat. No. D997721.
(60) Provisional application No. 62/815,446, filed on Mar. 8, 2019.

(51) Int. Cl. B65D 81/38; A47G 19/22; B65D 51/24; B65D 81/18; F25D 3/00; G01K 1/024; G08B 21/18; H04Q 9/02

(52) U.S. Cl. CPC B65D 81/3841; A47G 19/2227; A47G 19/2288; B65D 51/242; B65D 81/18; F25D 3/00; G01K 1/024; G08B 21/182; H04Q 9/02; A47G 2019/225; B65D 2203/12; F25D 2303/0831; F25D 2700/16; H04Q 2209/40

(57) ABSTRACT

A portable thermal insulated apparatus for cooling or heating stored items is provided. The portable thermal insulated apparatus includes a container having an open upper end, a thermal unit disposed within the container, and a lid removably securable to the open upper end via cooperating threading. The thermal unit includes a top opening providing access to a thermal unit interior configured to receive liquid, and a sidewall defining a sealed chamber containing a phase change material distinct from the thermal unit interior. When the lid is secured to the container, the lid simultaneously seals the container and the opening of the thermal unit. The lid is further configured to maintain engagement with the thermal unit during rotation, such that unthreading the lid withdraws the thermal unit from the container. This integrated sealing and extraction structure improves temperature regulation, ease of filling, and convenient removal for cleaning and reuse.

### CROSS REFERENCE TO RELATED APPLICATION

This application is a continuation of U.S. application Ser. No. 18/203,790, filed May 31, 2023, which is a continuation of U.S. application Ser. No. 17/583,406, filed Jan. 25, 2022, which is a continuation of U.S. application Ser. No. 16/802,648, filed Feb. 27, 2020, which is a continuation of U.S. Design application Ser. No. 29/692,216, filed May 23, 2019, and which further claims the benefit of U.S. Provisional Application No. 62/815,446, filed Mar. 8, 2019. Each of the above-identified applications is incorporated herein by reference in its entirety.

### BACKGROUND OF THE INVENTION

The present invention relates to portable temperature regulation devices. More specifically, the present invention relates to a portable thermal insulated apparatus including a removable internal thermal unit and a lid configured to both seal and extract the thermal unit from a container for maintaining a desired temperature of liquids and solids stored therein.

Individuals who transport temperature-sensitive contents, such as beverages, food items, or expressed breastmilk, require reliable and portable systems capable of maintaining safe storage temperatures. Existing insulated bags and containers typically rely on loose ice packs or external cooling elements that provide limited thermal retention, are difficult to clean, and require separate components for heating and cooling. These systems often lack structural integration between the cooling element and the container, resulting in inefficient temperature transfer, bulkiness, leakage risk, and inconvenience during use and cleaning

Additionally, existing devices generally do not incorporate a removable internal thermal insert that can be easily filled, sealed, and extracted from within the container using a single motion. Many devices require separate warming units to raise stored liquids to a desired temperature, thereby increasing complexity and reducing portability. There remains a need for a portable apparatus that integrates a fillable thermal unit within a container, allows for both cooling and heating functionality, and enables convenient removal and resealing of the thermal unit without requiring disassembly of multiple components.

In view of the foregoing, there exists a need for a portable thermal insulated apparatus that improves temperature regulation efficiency, ease of cleaning, structural durability, and user convenience. The present invention addresses these needs through an integrated lid and thermal unit configuration that enhances functionality and portability.

### SUMMARY OF THE INVENTION

In view of the foregoing disadvantages inherent in known portable temperature-regulating devices, the present invention provides a portable thermal insulated apparatus configured for selectively heating and cooling liquids and solids stored therein. The apparatus includes a container having an open upper end and an interior cavity, a thermal unit disposed within the interior cavity, and a lid removably securable to the open upper end of the container.

The thermal unit includes a top portion defining an opening that provides access to a thermal unit interior configured to receive liquid. The thermal unit further includes a sidewall extending between the top portion and a bottom portion, the sidewall defining a sealed chamber containing a phase change material distinct from the thermal unit interior. The phase change material provides controlled heating or cooling to contents stored within the container through thermal transfer across the thermal unit structure.

When the lid is secured to the container, the lid sealingly engages the opening of the thermal unit to seal liquid within the thermal unit interior and simultaneously seals the interior of the container. In this manner, a single threaded engagement both closes the container and seals the thermal unit, thereby simplifying use and reducing leakage risk.

The lid includes an external fastener configured to engage a corresponding internal fastener of the container. The lid is further configured to maintain engagement with the thermal unit during rotational disengagement from the container, such that unthreading the lid withdraws the thermal unit from the interior cavity. In one embodiment, the bottom of the thermal unit includes a protrusion configured to engage a complementary recess formed in a bottom interior surface of the container to resist rotation of the thermal unit during lid rotation. In another embodiment, the container includes an internal diameter transition aligned with a circumferential recessed portion of the thermal unit to control axial positioning and rotational stability.

The portable thermal insulated apparatus thereby provides improved temperature regulation, convenient filling and removal of the thermal unit, enhanced structural stability during use, and increased ease of cleaning and reuse compared to conventional insulated containers and loose ice pack systems.

It is therefore an object of the present invention to provide a new and improved portable thermal insulated apparatus that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the portable thermal insulated apparatus.

FIG. 2 shows an exploded view of an embodiment of the portable thermal insulated apparatus.

FIG. 3 shows a cross-sectional view of a lid of an embodiment of the portable thermal insulated apparatus.

FIG. 4 shows a cross-sectional view of an embodiment of the portable thermal insulated apparatus.

FIG. 5 shows a planar view of the bottom exterior of the thermal unit of an embodiment of the portable thermal insulated apparatus.

FIG. 6 shows a planar view of the bottom interior of the container of an embodiment of the portable thermal insulated apparatus.

### DETAILED DESCRIPTION OF THE INVENTION

Reference is made herein to the attached drawings. Like reference numerals are used throughout the drawings to depict like or similar elements of the portable thermal insulated apparatus. For the purpose of presenting a brief and clear description of the present invention, the preferred embodiment will be discussed as used for heating and cooling liquids and solids stored therein. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

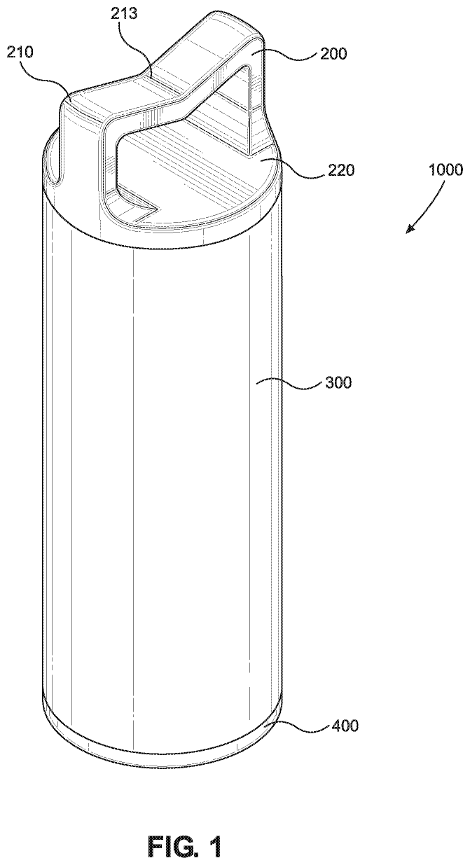

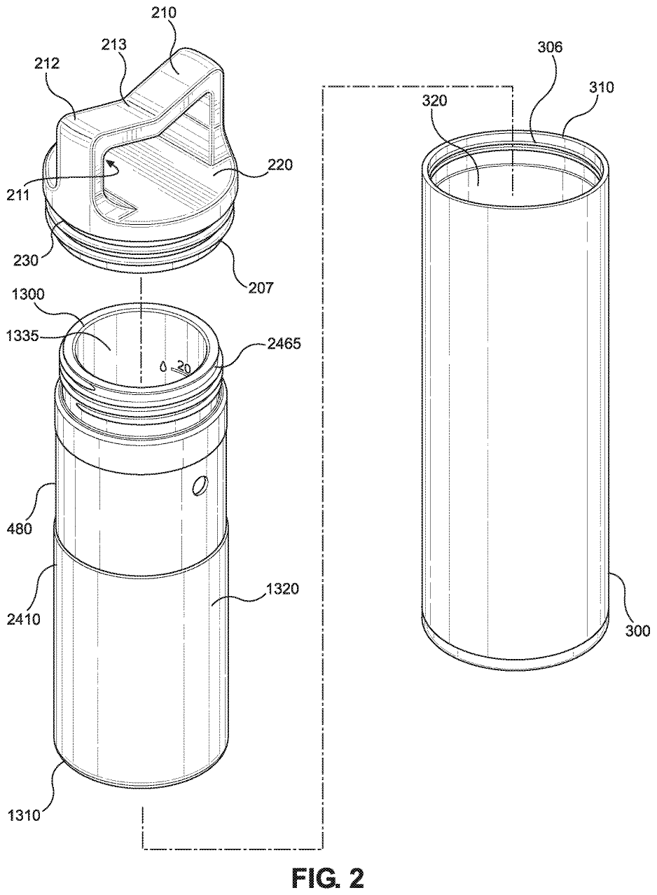

Referring now to FIGS. 1 and 2, there is shown a perspective view and an exploded view of an embodiment of the portable thermal insulated apparatus 1000, respectively. The present invention is directed to a portable thermal insulated apparatus 1000 that incorporates a cooperative lid 200, container 300, and removable thermal unit 2410 configured such that rotation of the lid performs multiple sequential mechanical functions. This cooperative multi-stage rotational interaction is achieved through a dual-threaded engagement system in combination with a rotational alignment structure that converts rotational motion of the lid into controlled axial displacement of the thermal unit while preventing unintended rotation of the thermal unit within the container.

In the illustrated embodiment, the lid 200 removably secures to an open upper end 310 of the container 300, and the thermal unit 2410 is configured to be disposed within an interior cavity 320 of the container. The thermal unit 2410 is configured to receive liquid directly therein and maintain a desired temperature for liquids and solids stored within the container 300.

The container 300 defines a hollow interior cavity 320 adapted to receive food, medicine, liquids, or other stored contents through the open upper end 310. In some embodiments, liquid may be received directly within the container 300. The container 300 may be cylindrical, as illustrated, or may comprise any suitable shape configured to receive the thermal unit 2410.

In certain embodiments, the container 300 includes a coaxially aligned inner wall and outer wall forming an insulated double-wall construction sealed at opposing ends. In other embodiments, the container 300 may comprise a single-wall construction or a multi-wall insulated structure including vacuum insulation, foam insulation, or other thermal barriers. The container may be cylindrical or non-cylindrical in cross-section and may be formed from food-grade stainless steel or other suitable materials. In one embodiment, the portable thermal insulated apparatus 1000 is approximately 68 mm in diameter and 226.4 mm in length, though dimensions may vary.

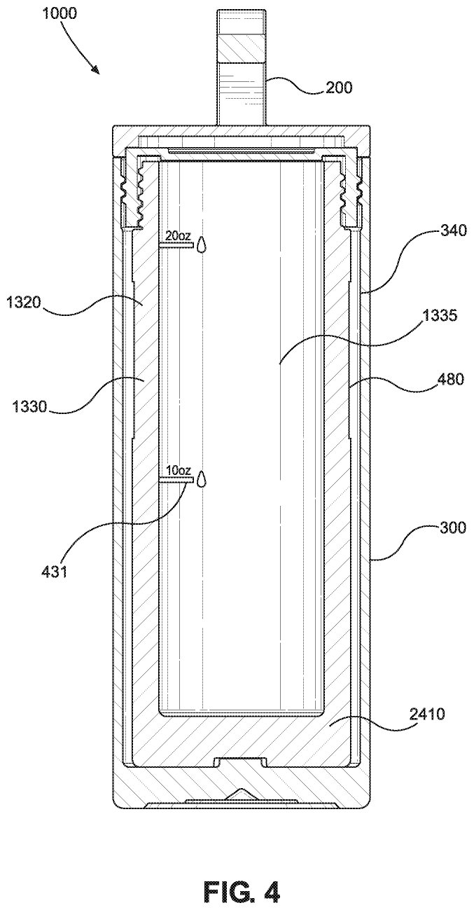

The thermal unit 2410 comprises a top portion defining an opening 1300, a bottom portion 1310, and a sidewall 1320 extending therebetween. The opening 1300 provides access to a thermal unit interior 1335 configured to receive fluid directly therein. As shown in FIG. 4, the thermal unit interior 1335 may include volume indicia 431 to indicate fill levels.

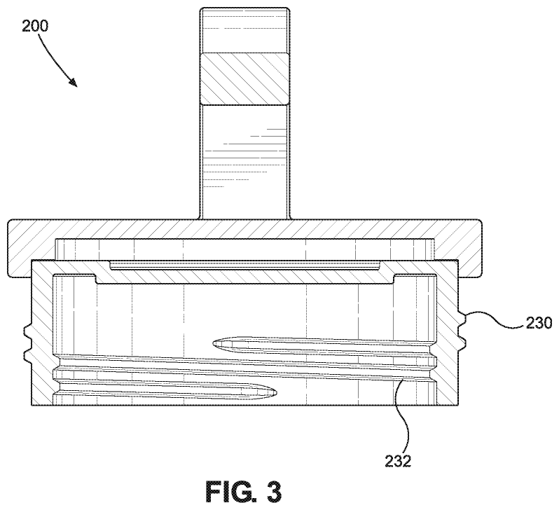

Referring now to FIGS. 3 and 4, the lid 200 is threadedly engageable with the container 300 through a first threaded interface 230 and is further threadedly engageable with the thermal unit 2410 through a second threaded interface 232. The first threaded interface 230 is disposed on the exterior of an interior wall 207 of the lid 200, which is positioned within the container 300 when the lid is secured thereto. The second threaded interface 232 is disposed on an interior surface of the interior wall 207.

In certain embodiments, the first threaded interface 230 comprises fewer thread turns or a shorter threaded engagement length than the second threaded interface 232. This arrangement allows the thermal unit 2410 to secure to the lid prior to full engagement between the lid and the container. Likewise, during disassembly, the container may release from the lid while threaded engagement between the lid 200 and the thermal unit 2410 is maintained.

The open upper end 310 of the container 300 includes an internal fastener 306 configured to engage the first threaded interface 230. The opening 1300 of the thermal unit 2410 includes an exterior fastener 2465 configured to engage the second threaded interface 232. In the illustrated embodiment, the fasteners 306 and 2465 comprise corresponding threading, although alternate fastening mechanisms such as press-fit or mating male/female interfaces may be utilized.

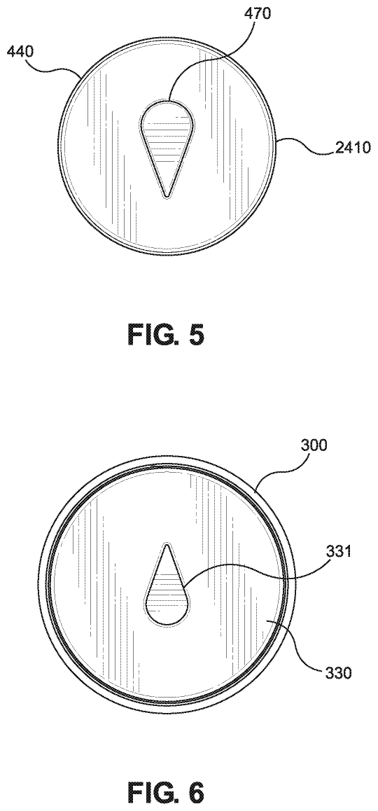

In the illustrated embodiment, the thermal unit 2410 includes an anti-rotation structure, such as a recess 470, configured to engage a complementary protrusion 331 formed in the bottom interior surface 330 of the container 300 (as seen in FIGS. 5 and 6). When the lid 200 is rotated relative to the container 300, engagement between the anti-rotation structure and the complementary structure restrains the thermal unit 2410 against rotation relative to the container. This restraint converts rotational motion of the lid into axial displacement of the thermal unit relative to the container.

In alternative embodiments, the anti-rotation structure may comprise one or more recesses, protrusions, tabs, flats, splines, keyed features, polygonal engagement geometries, or other non-circular mating structures configured to resist relative rotational movement between the thermal unit and the container. The anti-rotation structure may be positioned at a bottom portion, sidewall, upper portion, or any other mating surface of the thermal unit and container. Further, the recess or protrusion may be formed on either the thermal unit or the container, with a complementary feature formed on the other component.

In this way, the anti-rotation structure relies on cooperative engagement between corresponding structures of the thermal unit 2410 and the container 300 to limit rotational movement while permitting axial displacement during threaded engagement and disengagement. In certain embodiments, the engagement geometry may permit insertion of the thermal unit into the container in one or more predefined angular orientations corresponding to alignment of the mating features. This controlled orientation ensures consistent engagement of the dual-threaded interfaces and reduces the likelihood of unintended loosening or independent rotation of the thermal unit during use.

Due to the longitudinal travel inherent in threaded fastener systems, the recess 470 and protrusion 331 are dimensioned to accommodate axial displacement of the thermal unit 2410 during rotational engagement and disengagement of the lid 200. The geometry of these features permits sufficient axial travel while maintaining rotational restraint throughout at least a portion of the lid's threaded disengagement sufficient to withdraw the thermal unit from the container.

In a closed configuration, a lowermost exterior edge of the lid 200 is positioned above an uppermost edge of a sidewall of the container 300, and the outer surface of the lid and the outer surface of the container are substantially coextensive. This substantially flush exterior profile enhances structural continuity between the lid and container, reduces exposed edges that may collect debris, improves ergonomic handling, and may contribute to improved impact resistance by distributing forces across the lid-to-container interface.

The lid 200 includes an upper surface 220 and, in the illustrated embodiment, a handle 210 extending upward therefrom, as shown in FIGS. 1 and 2. The handle 210 forms a finger-receiving opening 211 between an upper portion 212 and the upper surface 220 to facilitate ergonomic grasping during opening, closing, and transport. In alternate embodiments, the lid 200 may omit the handle or include alternate gripping structures.

The sidewall 1320 defines a sealed chamber 1330 containing a phase change material. The sealed chamber 1330 is radially outward of and distinct from the thermal unit interior 1335 and is fluidly isolated therefrom such that liquid introduced through the opening 1300 enters only the thermal unit interior 1335. The phase change material may be selected to absorb or release thermal energy at a desired transition temperature and may be configured for cooling or warming applications.

In certain embodiments, the sidewall 1320 may comprise metal, polymer, composite, or multi-material constructions. The sealed chamber 1330 may be formed through welding, brazing, adhesive bonding, ultrasonic sealing, overmolding, or other sealing techniques sufficient to maintain fluid isolation between the sealed chamber 1330 and the thermal unit interior 1335.

In the illustrated embodiment, the thermal unit interior 1335 comprises at least 70% of the volume of the interior cavity 320 of the container 300 and extends at least 75% of the length of the container 300. In alternate embodiments, the thermal unit 2410 may occupy only a portion of the interior cavity 320, permitting simultaneous storage of additional items within the container. Thermal units of varying lengths, volumes, and phase change material capacities may be interchangeably used with a common container and lid configuration.

In the illustrated embodiment, the threaded engagements between the lid and container and between the lid and thermal unit are oriented in the same rotational direction, although alternate embodiments may utilize opposing thread orientations. When the thermal unit 2410 is outside of the container 300, rotation of the lid 200 in a securing direction engages the internal threading 232 of the lid with the external threading 2465 of the thermal unit. Continued rotation advances the lid axially relative to the thermal unit, thereby sealing the opening 1300 and securing the components together.

When the thermal unit 2410 is inserted into the container 300 and aligned such that the recess 470 engages the protrusion 331, rotation of the lid 200 in the securing direction engages the threaded interface between the lid and the container. Continued rotation draws the lid axially relative to the container, seating the thermal unit and sealing both the container interior and the thermal unit interior.

If the thermal unit 2410 is not present, rotation of the lid 200 in the securing direction engages only the threaded interface between the lid and container, sealing the interior cavity.

To open the apparatus 1000, rotation of the lid 200 in an opposite direction disengages the threaded interface between the lid and container. Because the thermal unit 2410 is restrained against rotation by the recess 470 and protrusion 331, engagement between the lid and thermal unit is maintained during at least a portion of this rotation, causing axial withdrawal of the thermal unit from the container. Continued rotation thereafter disengages the lid from the thermal unit.

In certain embodiments, the threaded interfaces may comprise single-start or multi-start threads, and the thread pitch may be selected to provide controlled axial displacement. Engagement between the lid and thermal unit may alternatively be achieved through snap-fit, bayonet-style, frictional, magnetic, or other mechanical coupling structures.

The thermal unit 2410 is removable and interchangeable. Multiple thermal units may be provided, each configured to achieve different heating or cooling effects. For example, a first thermal unit may contain a phase change material optimized for refrigeration, while a second thermal unit may be configured for warming to body temperature. In some embodiments, a thermal unit 2410 may be placed in a freezer to achieve a frozen temperature, while another thermal unit may be microwavable. The removability and interchangeability of the thermal units allow a single container 300 and lid 200 to be used for multiple temperature-regulation applications.

In use, the apparatus operates through a sequential rotational interaction between the lid 200, the thermal unit 2410, and the container 300. In a first step, the thermal unit 2410 is positioned within the interior cavity 320 of the container 300 such that the recess 470 aligns with and engages the protrusion 331. Rotation of the lid 200 in a securing direction engages the threaded interface between the lid and the thermal unit and subsequently engages the threaded interface between the lid and the container. Continued rotation advances the lid axially relative to the container, thereby simultaneously sealing the opening 1300 of the thermal unit interior 1335 and sealing the interior cavity 320 of the container.

In a second step, rotation of the lid 200 in an opposite direction disengages the threaded interface between the lid and the container while the anti-rotation engagement between the recess 470 and protrusion 331 restrains the thermal unit against rotation. As a result, continued opposite rotation maintains engagement between the lid and the thermal unit and causes axial withdrawal of the thermal unit from the container. Further rotation in the same opposite direction thereafter disengages the lid from the thermal unit.

Through this two-stage rotational interaction, the apparatus enables sealing, extraction, and reseparation of components using a single continuous rotational direction for closing and a single continuous opposite rotational direction for opening.

The portable thermal insulated apparatus 1000 thus provides integrated temperature regulation, simplified filling and removal of the thermal unit, enhanced structural stability during use, and convenient interchangeability of heating and cooling elements within a single portable system.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A portable thermal insulated apparatus, comprising:
a container having an open upper end and an interior cavity, the container configured to store fluid therein;
a thermal unit disposed within the interior cavity of the container, wherein the thermal unit comprises an opening providing access to a thermal unit interior;
a lid configured to be removably securable to the open upper end of the container, the lid including an external fastener configured to engage an internal fastener of the container;
wherein the lid is configured to engage the thermal unit wherein rotation of the lid relative to the container about a first direction disengages the lid from the container while maintaining engagement between the lid and the thermal unit, thereby allowing cooperative withdrawing of the lid and the thermal unit from the interior cavity of the container.

2. The portable thermal insulated apparatus of claim 1, wherein the external fastener includes a first threaded interface configured to engage the container and the internal fastener includes a second threaded interface configured to engage the thermal unit, and wherein rotation of the lid in the first direction disengages the first threaded interface while maintaining engagement of the second threaded interface.

3. The portable thermal insulated apparatus of claim 2, wherein the first engagement interface and the second engagement interface are independently operable to selectively engage the container and the thermal unit.

4. The portable thermal insulated apparatus of claim 3, wherein the second engagement interface engages the thermal unit prior to full engagement of the first engagement interface with the container during rotation in a securing direction.

5. The portable thermal insulated apparatus of claim 3, wherein disengagement of the first engagement interface from the container occurs while the second engagement interface remains engaged with the thermal unit during rotation in an opposite direction.

6. The portable thermal insulated apparatus of claim 1, wherein the first engagement interface is disposed on an exterior side of an interior wall of the lid and configured to threadedly fasten to an interior side of the container.

7. The portable thermal insulated apparatus of claim 6, wherein the second engagement interface is disposed on an interior side of the interior wall of the lid and configured to threadedly fasten to an exterior side of the thermal unit.

8. The portable thermal insulated apparatus of claim 2, wherein tightening of the lid simultaneously (i) seals the interior of the container and (ii) seals the thermal unit interior in a seated configuration.

9. The portable thermal insulated apparatus of claim 1, wherein a sidewall of the thermal unit defines a sealed chamber containing a phase change material, the sealed chamber being distinct from and radially surrounding the thermal unit interior.

10. The portable thermal insulated apparatus of claim 9, wherein the phase change material is configured to cool an interior of the container.

11. The portable thermal insulated apparatus of claim 9, wherein the sealed chamber is fluidly isolated from the thermal unit interior and from the opening of the thermal unit.

12. The portable thermal insulated apparatus of claim 9, wherein an outside diameter of the sidewall of the thermal unit is in close tolerance of approximately between 2-6 mm with an interior diameter of a wall of the container.

13. The portable thermal insulated apparatus of claim 1, wherein the thermal unit interior comprises a volume of at least 70% of a volume of the interior of the container.

14. The portable thermal insulated apparatus of claim 1, wherein the thermal unit comprises a length of at least 75% of a length of the container.

15. The portable thermal insulated apparatus of claim 1, wherein a closed configuration, the lid is secured to the thermal unit, and the lid and thermal unit are cooperatively secured to the container, wherein the closed configuration, a lowermost exterior edge of the lid is positioned above an uppermost edge of a sidewall of the container.

16. The portable thermal insulated apparatus of claim 15, wherein the closed configuration, an outer side of the lid and an outer side of the sidewall of the container are coextensive.

17. The portable thermal insulated apparatus of claim 1, wherein the lid includes a sealing member configured to engage an upper rim of the container.

18. The portable thermal insulated apparatus of claim 1, further comprising an anti-rotation structure defined by cooperative engagement between a first engagement feature formed on one of the thermal unit or the container and a complementary engagement feature formed on the other of the thermal unit or the container, the anti-rotation structure being configured to resist relative rotational movement between the thermal unit and the container during rotation of the lid while permitting axial displacement of the thermal unit within the interior cavity.

19. The portable thermal insulated apparatus of claim 18, wherein the first engagement feature comprises a recess and the complementary engagement feature comprises a protrusion.

20. The portable thermal insulated apparatus of claim 1, wherein the container includes an internal diameter transition defining an internal shoulder, and wherein the thermal unit includes a circumferential recessed portion positioned to align with the internal shoulder to control axial positioning and resist rotational movement of the insert relative to the container.
